(19) United States
(12) Patent Application Publication
(10) Pub. No.: US 2011/0114748 A1
(43) Pub. Date: May 19, 2011

(54) SPRINKLER RUNOFF CONSERVATION SYSTEM

(76) Inventor: Marc Boyajian, Tujunga, CA (US)

(21) Appl. No.: 12/622,155

(22) Filed: Nov. 19, 2009

(51) Int. Cl. B05B 12/02

(52) U.S. Cl. 239/70

(57) ABSTRACT

The system includes a water source, tubing sections, sprinkler heads and a drainage system that collects excess water from the sprinklers and provides a gravity-fed path to a collection point at a sump below the collection point. A sump pump is located within the sump and supplies pressurized water to the sprinkler system. A water line is controlled by a level shutoff switch, and provides water to the sump, filling it prior to operation of the sump pump and the sprinkler system. A timer controls the level shutoff switch, causing the sump to be filled at a predetermined time. The timer controls the pump providing water to the sprinkler system after the predetermined time for a predetermined duration. A pressure sensor is fluidly connected to the system between the sump pump and the sprinkler head and electrically connected to the timer and the pump, cutting power when system pressure drops.

### FIELD OF INVENTION

This invention relates to the field of lawn sprinkler systems more specifically to systems for minimizing the unnecessary use of irrigation water and collecting and recycling water distributed by sprinkler systems.

### BACKGROUND OF THE INVENTION

In many areas automatic lawn sprinkler systems are used to water lawns and gardens. These systems use enormous amounts of potable water, a sizable portion of which is not absorbed and used efficiently by plants that the systems water, but rather ends up as runoff. This runoff exits lawns and flower beds through drainage piping and systems that divert the runoff into streets, sewers and eventually oceans, rivers and streams. As water for irrigating and drinking becomes increasingly scarce, systems to conserve and recycle irrigation water become increasingly desirable. It is estimated that 83 trillion gallons of water are used for irrigation each year in the United States alone. If even 3%-5% of this amount could be collected and recycled, the savings would be significant. The present invention addresses this problem. Various water collection systems have been developed by inventors.

U.S. Patent Application No. 2008/0128030, published for Lewis is directed to systems and methods for collecting, storing, and redistributing water, which systems and methods make use of building foundations and surface concrete slab structures. A variety of rainwater collectors are anticipated, including rooftop collection systems (e.g., gutters) and ground surface covering structures (driveways, sidewalks, parking lots, and patios). These collection systems are joined together in a collection conduit system that carries the rainwater to one or more rainwater containment vessels. The stored water may then be redistributed, again through a variety of distribution means, to address part or all of the landscape watering requirements of the property. The system takes advantage of standard foundation and slab construction techniques to establish a major portion of the structure required for the containment vessel.

U.S. Pat. No. 4,934,404, issued to Destafano illustrates a water management system including a receptacle that is mounted to the roof of a building for collecting water runoff from the roof. There is an underground reservoir and a first conduit interconnects the receptacle and the reservoir for conducting runoff from the receptacle to the reservoir for storage therein. A second conduit is connected to the reservoir forming an outlet therefrom.

The stored water is pumped out of the reservoir to the second conduit and is dispensed to irrigate a predetermined region.

U.S. Pat. No. 5,407,562, issued to Baldino discloses an apparatus to effect the reclaiming of waste water includes a storage tank in operative communication through filtration tanks, that in turn receives water from an enclosed preliminary filtration container. From the storage tank, a delivery pump provides for the coupling of water hoses to obtain water from the storage tank structure.

U.S. Pat. No. 6,299,775, issued to Elston discloses a waste and wastewater treatment and recycling system separates blackwater and greywater at their respective sources and includes a waste separation system for decomposing the blackwater into water vapor and carbon dioxide gas, a wastewater treatment system for circulating, aerating, and separating the greywater into precipitated solid matter and treated water, and a filtration, disinfection, and water recycling system for filtering and disinfecting the treated water to form recyclable water. The precipitated solid matter is transferred to the waste separation system and the recyclable water is passed through a membrane filtration system to form potable water. A monitoring system monitors and controls operation of the waste separation system, the wastewater treatment system, and the filtration, disinfection, and water recycling system.

U.S. Pat. No. 6,016,971, issued to Welch et al. discloses a system for automatically controlling a lawn watering system responsive to the moisture content of the soil includes at least one moisture sensor which supplies a signal to a moisture controller to actuate a water supply valve. The moisture sensor has a casing containing two electrodes and an insulating body of synthetic fibers which provide a path to transfer water from the soil to the electrodes.

U.S. Pat. No. 6,016,971, issued to Welch et al. discloses a plurality of irrigation sprinklers that are sequentially operated for timed intervals by an electrical control system having a timing mechanism through which valve solenoids are energized. Selected solenoid circuits are opened by eliminator switches to bypass desired sprinkler locations during timed irrigation cycles. Through a locator panel portion, the sprinklers in operation are identified and the operating period of desired sprinklers extended beyond the time interval.

U.S. Pat. No. 3,297,254, issued to Coffman discloses a sprinkler system that includes a rain collection pan. The pan includes a pair of electrodes that are shorted together by a collection of rain water in the pan. When so shorted together, a motor connected in circuit with the electrodes will not operate to close contacts to energize solenoids controlling water flow to the sprinkler heads. Thus when there is rainwater collected in the pan, the sprinkler system will not operate.

It is an objective of the present invention to provide a system for collecting runoff from lawn and garden sprinkler systems that include in ground drainage piping. It is a further objective to provide a system that is integrated with a water supply system insure that sufficient water is available for redistribution to lawns and gardens. It is a still further objective of the invention to provide a conservation system that measures relative moisture at delivery sites and only provides watering when the moisture content of the soil reaches a predefined level. It is another objective to provide a system that senses a pressure drop in an irrigation line and closes off water flow to that line. Finally, it is an objective of the present invention to provide a system for collecting runoff from lawn and garden sprinkler systems that can be economically manufactured, installed and operated and that is durable and simple to use.

While some of the objectives of the present invention are disclosed in the prior art, none of the inventions found include all of the requirements identified.

### SUMMARY OF THE INVENTION

The present invention addresses all of the deficiencies of prior art sprinkler runoff conservation system inventions and satisfies all of the objectives described above.

(1) A sprinkler runoff conservation system, providing all of the desired features can be constructed from the following components. A plant irrigating sprinkler system is provided. The sprinkler system includes a water source, at least one tubing section, and at least one sprinkler head. A drainage system is provided. The drainage system collects water from soil irrigated by the sprinkler system and provides a gravity-fed path to a collection point. A runoff collection sump is provided. The sump is connected to and located at a level below the collection point. An overflow drain is provided. The overflow drain is located at an upper level of the collection sump. The drain is fluidly connect to a community water runoff system and permits a volume of water exceeding a capacity of the sump to drain into the community runoff system.

A sump pump is provided. The sump pump is located within the sump and supplies pressurized water to the sprinkler system. A water fill line is provided. The fill line connects to the water source, is controlled by a water level shutoff switch, and provides a water supply to the collection sump. The water level shutoff switch allows the water fill line to fill the sump to a first predetermined level prior to operation of the sump pump and the sprinkler system. A sprinkler timer is provided. The sprinkler timer controls the water level shutoff switch, causing the sump to be filled to the first predetermined level at a predetermined time. The sprinkler timer controls the sump pump to provide pressurized water to the sprinkler system after the predetermined time and for a predetermined duration. A humidity sensor is provided. The humidity sensor is electrically connected to the sump pump and provides power to the pump only when humidity is determined by the sensor to be below a predetermined humidity level.

A pressure sensor is provided. The pressure sensor is fluidly connected to the sprinkler system between the sump pump and the sprinkler head and electrically connected to the sprinkler timer and the sump pump. The pressure sensor measures pressure in the tubing section during an irrigation period. The irrigation period begins a predetermined time after activation of the sump pump by the sprinkler timer and ends at shutdown of the sump pump by the timer. The pressure sensor terminates power to the sump pump upon detecting a predetermined pressure drop in the tubing section during the irrigation period. When water provided by either rain or the sprinkler system drains into the runoff collection sump, the water is reused for irrigation when the sump pump is controlled by the sprinkler timer, the humidity sensor and the pressure sensor to supply pressurized water to the sprinkler system.

(2) In a variant of the invention, at least one sprinkler line shutoff valve is provided. The shutoff valve is electrically operated and is connected between the sump pump and a first sprinkler head connected to any of the tubing sections. The first sprinkler head is connected to the tubing section at a point closer to the sump pump along the tubing section than any other sprinkler head connected to the tubing section. The shutoff valve permits water flow when energized by the sprinkler timer and prevents water flow either when the sprinkler timer ceases to energize the shutoff valve or when the pressure sensor detects the predetermined pressure drop in the tubing section during the irrigation period. The sprinkler timer energizes a subsequent shutoff valve connected between the sump pump and a subsequent tubing section and permits water flow during a subsequent irrigation period subject to control by a second pressure sensor.

(3) In another variant, the drainage system further includes at least one entry point. The entry point is located at a low elevation point of the soil irrigated by the sprinkler system. The entry point is fluidly connected to either underground piping or channels leading downwardly to the collection point.

(4) In still another variant, the drainage system further includes a layer of aeration material disposed below the soil irrigated by the sprinkler system. An accumulation pan is provided. The pan is formed of water impervious material, located below the aeration material and provides the gravity-fed path to the collection point.

(5) In yet another variant, the aeration material is selected from the group that includes rocks, concrete fragments and brick fragments.

(6) In a further variant, the drainage system further includes a mold and mildew resistant coating applied to any of the aeration material, the accumulation pan and the collection sump.

(7) In yet a further variant, the runoff collection sump further includes a removable, cleanable filter. The filter is located adjacent the collection point and provides a diversion path to the community runoff system should the filter be sufficiently clogged to prevent water flow through the collection point into the collection sump.

(8) In still a further variant, the sump pump further includes a float switch. The float switch cuts power to the pump if water in the collection sump falls below a second predetermined level.

(9) In another variant of the invention, the sprinkler line shutoff valve further includes a manual shutoff feature to permit timely repair of broken sprinkler heads or the tubing section to which the shutoff valve is fluidly connected.

(10) In a final variant, the sprinkler runoff conservation system further includes either a visual or auditory signal. The signal is activated when the pressure sensor detects the predetermined pressure drop in the tubing section during the irrigation period.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a side elevational cross-section of the preferred embodiment of the invention illustrating an accumulation pan, aeration material and a collection sump;

FIG. 2 is a side elevational cross-section of a second embodiment illustrating underground drainage channels;

FIG. 3 is a side elevational cross-section of the collection sump and a schematic view of the connections of the system sensors; and

FIG. 4 is a perspective view of a third embodiment of the invention illustrating multiple sprinkler lines and sprinkler line shutoff valves.

### DETAILED DESCRIPTION OF THE PREFERRED EMBODIMENT

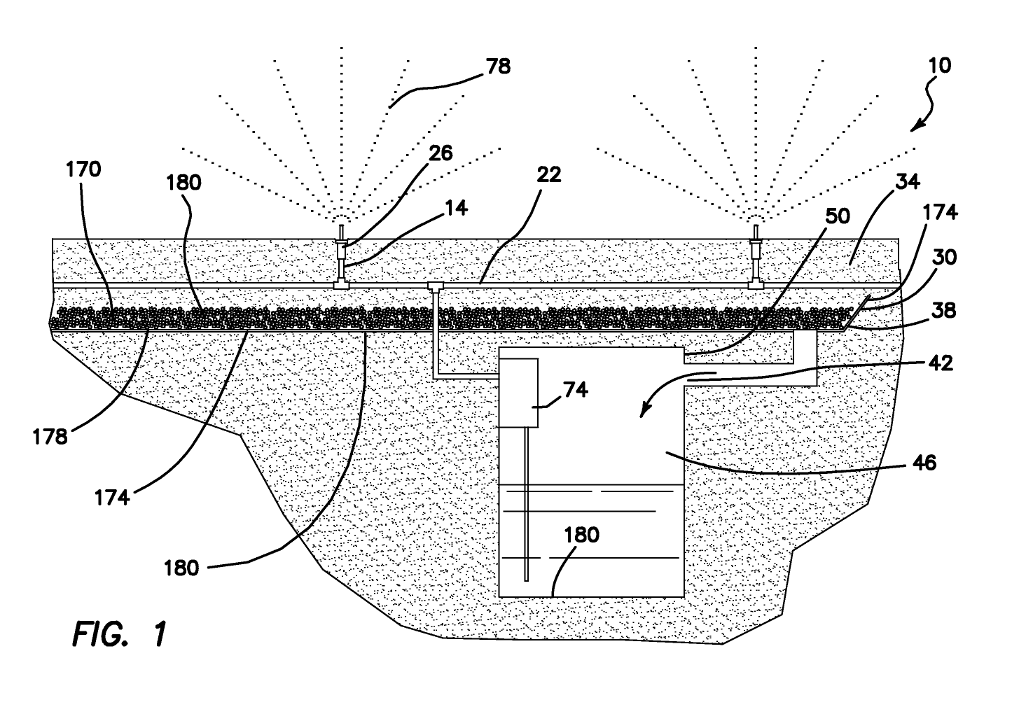

(1) FIGS. 1-4 illustrate a sprinkler runoff conservation system 10, providing all of the desired features that can be constructed from the following components. A plant irrigating sprinkler system 14 is provided. The sprinkler system 14 includes a water source (not shown), at least one tubing section 22, and at least one sprinkler head 26. A drainage system 30 is provided. The drainage system 30 collects water from soil 34 irrigated by the sprinkler system 14 and provides a gravity-fed path 38 to a collection point 42. A runoff collection sump 46 is provided. The sump 46 is connected to and located at a level 50 below the collection point 42. An overflow drain 54 is provided. The overflow drain 54 is located at an upper level 58 of the collection sump 46. The drain 54 is fluidly connect to a community water runoff system (not shown) and permits a volume of water 66 exceeding a capacity 70 of the sump 46 to drain into the community runoff system.

A sump pump 74 is provided. The sump pump 74 is located within the sump 46 and supplies pressurized water 78 to the sprinkler system 14. A water fill line 82 is provided. The fill line 82 connects to the water source 18, is controlled by a water level shutoff switch 86, and provides a water supply 90 to the collection sump 46. The water level shutoff switch 86 allows the water fill line 82 to fill the sump 46 to a first predetermined level 94 prior to operation of the sump pump 74 and the sprinkler system 14. A sprinkler timer 98 is provided. The sprinkler timer 98 controls the water level shutoff switch 86, causing the sump to be filled to the first predetermined level 94 at a predetermined time 102. The sprinkler timer 98 controls the sump pump 74 to provide pressurized water 78 to the sprinkler system 14 after the predetermined time 102 and for a predetermined duration 106. A humidity sensor 110 is provided. The humidity sensor 110 is electrically connected to the sump pump 74 and provides power to the pump 74 only when humidity is determined by the sensor 110 to be below a predetermined humidity level.

A pressure sensor 122 is provided. The pressure sensor 122 is fluidly connected to the sprinkler system 14 between the sump pump 74 and the sprinkler head 26 and electrically connected to the sprinkler timer 98 and the sump pump 74. The pressure sensor 122 measures pressure in the tubing section 22 during an irrigation period 126. The irrigation period 126 begins a predetermined time 130 after activation of the sump pump 74 by the sprinkler timer 98 and ends at shutdown of the sump pump 74 by the timer 98. The pressure sensor 122 terminates power to the sump pump 74 upon detecting a predetermined pressure drop in the tubing section 22 during the irrigation period 126. When water 138 provided by either rain (not shown) or the sprinkler system 14 drains into the runoff collection sump 46, the water 138 is reused for irrigation when the sump pump 74 is controlled by the sprinkler timer 98, the humidity sensor 110 and the pressure sensor 122 to supply pressurized water 78 to the sprinkler system 14.

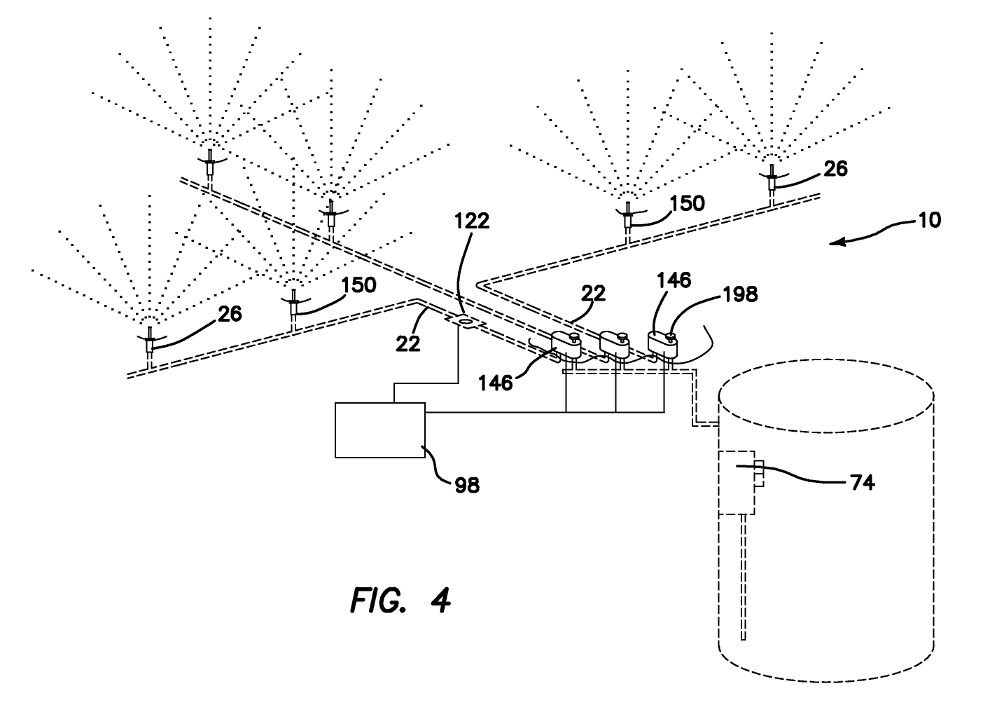

(2) In a variant of the invention, as illustrated in FIG. 4, at least one sprinkler line shutoff valve 146 is provided. The shutoff valve 146 is electrically operated and is connected between the sump pump 74 and a first sprinkler head 150 connected to any of the tubing sections 22. The first sprinkler head 150 is connected to the tubing section 22 at a point closer to the sump pump 74 along the tubing section 22 than any other sprinkler head 26 connected to the tubing section 22. The shutoff valve 146 permits water flow when energized by the sprinkler timer 98 and prevents water flow either when the sprinkler timer 98 ceases to energize the shutoff valve 146 or when the pressure sensor 122 detects the predetermined pressure drop 134 in the tubing section 22 during the irrigation period 126. The sprinkler timer 98 energizes a subsequent shutoff valve 146 connected between the sump pump 74 and a subsequent tubing section 22 and permits water flow during a subsequent irrigation period 126 subject to control by a second pressure sensor 122.

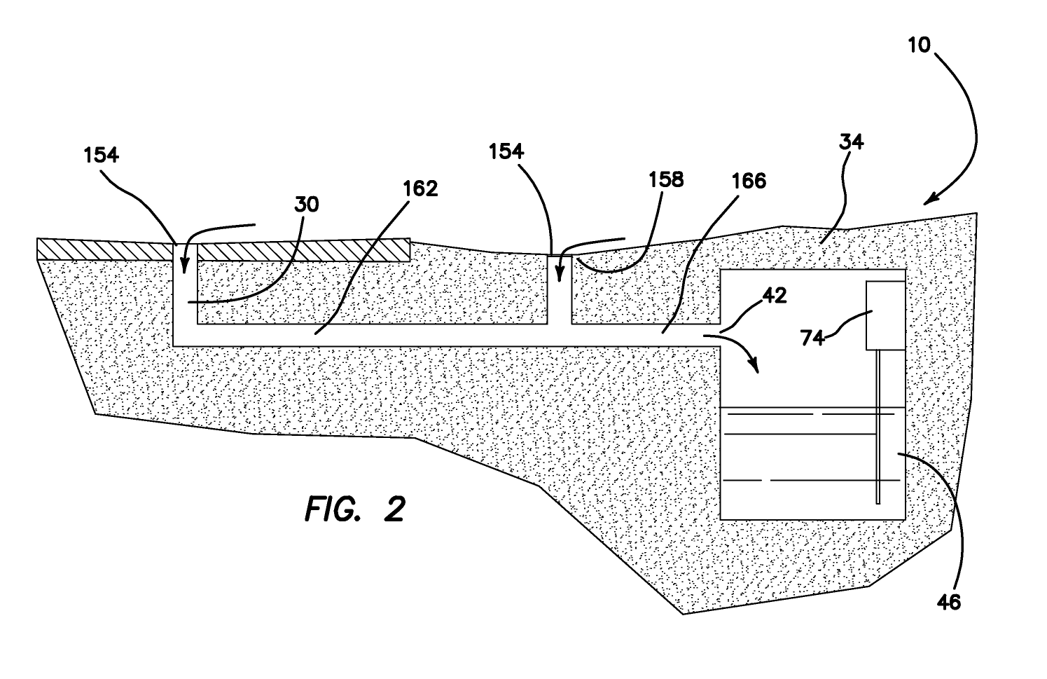

(3) In another variant, as illustrated in FIG. 2, the drainage system 30 further includes at least one entry point 154. The entry point 154 is located at a low elevation point 158 of the soil 34 irrigated by the sprinkler system 14. The entry point 154 is fluidly connected to either underground piping 162 or channels 166 leading downwardly to the collection point 42.

(4) In still another variant, as illustrated in FIG. 1, the drainage system 30 further includes a layer of aeration material 170 disposed below the soil 34 irrigated by the sprinkler system 14. An accumulation pan 174 is provided. The pan 174 is formed of water impervious material 178, located below the aeration material 170 and provides the gravity-fed path 38 to the collection point 42.

(5) In yet another variant, the aeration material 170 is selected from the group that includes rocks, concrete fragments and brick fragments.

(6) In a further variant, the drainage system 30 further includes a mold and mildew resistant coating 180 applied to any of the aeration material 170, the accumulation pan 174 and the collection sump 46.

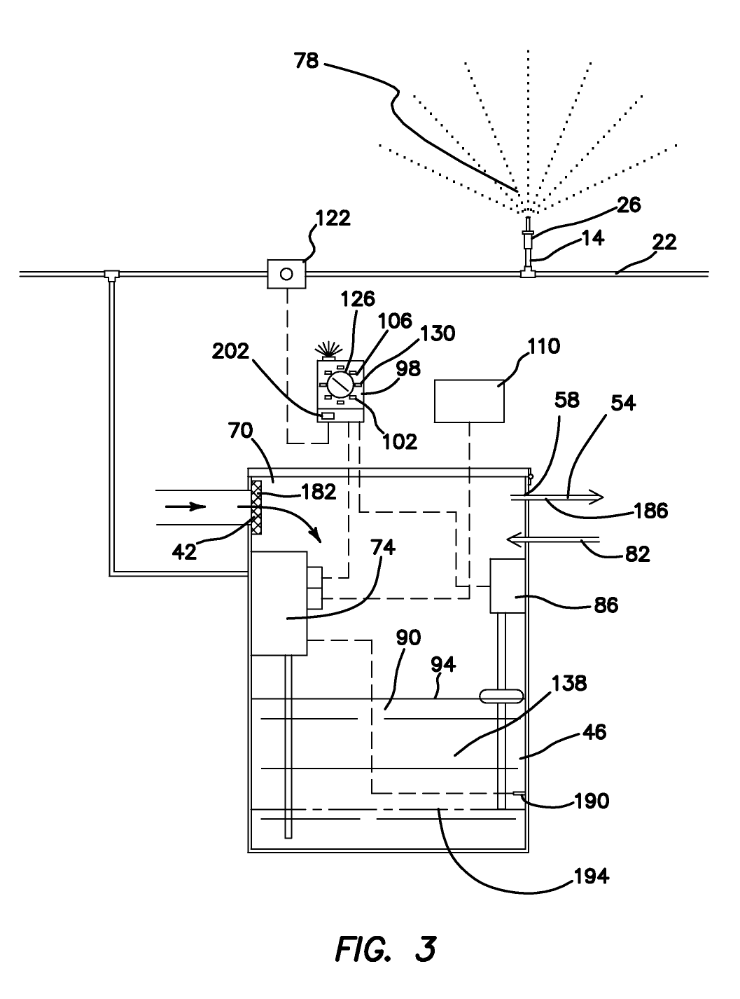

(7) In yet a further variant, as illustrated in FIG. 3, the runoff collection sump 46 further includes a removable, cleanable filter 182. The filter 182 is located adjacent the collection point 42 and provides a diversion path 186 to the community runoff system should the filter 182 be sufficiently clogged to prevent water flow through the collection point 42 into the collection sump 46.

(8) In still a further variant, the sump pump 74 further includes a float switch 190. The float switch 190 cuts power to the pump 74 if water in the collection sump 46 falls below a second predetermined level 194.

(9) In another variant of the invention, as illustrated in FIG. 4, the sprinkler line shutoff valve 146 further includes a manual shutoff feature 198 to permit timely repair of broken sprinkler heads 26 or the tubing section 22 to which the shutoff valve 146 is fluidly connected.

(10) In a final variant, as illustrated in FIG. 3, the sprinkler runoff conservation system 10 further includes either a visual or auditory signal 202. The signal 202 is activated when the pressure sensor 122 detects the predetermined pressure drop in the tubing section 22 during the irrigation period 126.

The sprinkler runoff conservation system 10 has been described with reference to particular embodiments. Other modifications and enhancements can be made without departing from the spirit and scope of the claims that follow.

1. A sprinkler runoff conservation system, comprising:
a plant irrigating sprinkler system, said sprinkler system comprising a water source, at least one tubing section, and at least one sprinkler head;
a drainage system, said drainage system collecting water from soil irrigated by said sprinkler system and providing a gravity-fed path to a collection point;
a runoff collection sump, said sump connected to and disposed at a level below said collection point;
an overflow drain, said overflow drain disposed at an upper level of said collection sump, being fluidly connect to a community water runoff system and permitting a volume of water exceeding a capacity of said sump to drain into said community runoff system;
a sump pump, said sump pump disposed within said sump and supplying pressurized water to said sprinkler system;
a water fill line, said fill line connects to said water source, controlled by a water level shutoff switch, and providing a water supply to said collection sump;
said water level shutoff switch allowing said water fill line to fill said sump to a first predetermined level prior to operation of said sump pump and said sprinkler system;
a sprinkler timer, said sprinkler timer controlling said water level shutoff switch, causing said sump to be filled to said first predetermined level at a predetermined time and controlling said sump pump to provide pressurized water to said sprinkler system after said predetermined time and for a predetermined duration;
a humidity sensor, said humidity sensor being electrically connected to said sump pump and providing power to said pump only when humidity is determined by said sensor to be below a predetermined humidity level;
a pressure sensor; said pressure sensor being fluidly connected to said sprinkler system between said sump pump and said sprinkler head and electrically connected to said sprinkler timer and said sump pump; and
said pressure sensor measuring pressure in said tubing section during an irrigation period, said irrigation period beginning a predetermined time after activation of said sump pump by said sprinkler timer and ending at shutdown of said sump pump by said timer, said pressure sensor terminating power to said sump pump upon detecting a predetermined pressure drop in said tubing section during said irrigation period; and
whereby, when water provided by either of rain and said sprinkler system drains into said runoff collection sump, said water is reused for irrigation when said sump pump is controlled by said sprinkler timer, said humidity sensor and said pressure sensor to supply pressurized water to said sprinkler system.

2. The sprinkler runoff conservation system, as described in claim 1, further comprising:
at least one sprinkler line shutoff valve, said shutoff valve being electrically operated and being connected between said sump pump and a first sprinkler head connected to any of said tubing sections, said first sprinkler head being connected to said tubing section at a point closer to said sump pump along said tubing section than any other sprinkler head connected to said tubing section;
said shutoff valve permitting water flow when energized by said sprinkler timer and preventing water flow either of when said sprinkler timer ceases to energize said shutoff valve and when said pressure sensor detects said predetermined pressure drop in said tubing section during said irrigation period; and
said sprinkler timer energizing a subsequent shutoff valve connected between said sump pump and a subsequent tubing section and permitting water flow during a subsequent irrigation period subject to control by a second pressure sensor.

3. The sprinkler runoff conservation system, as described in claim 1, wherein said drainage system further comprises:
at least one entry point, said entry point disposed at a low elevation point of said soil irrigated by said sprinkler system;
said entry point fluidly connected to either of underground piping and channels leading downwardly to said collection point.

4. The sprinkler runoff conservation system, as described in claim 1, wherein said drainage system further comprises:
a layer of aeration material disposed below said soil irrigated by said sprinkler system;
an accumulation pan, said pan being formed of water impervious material, disposed below said aeration material and providing said gravity-fed path to said collection point.

5. The sprinkler runoff conservation system, as described in claim 4, wherein said aeration material is selected from the group comprising:
rocks, concrete fragments and brick fragments.

6. The sprinkler runoff conservation system, as described in claim 4, wherein said drainage system further comprises a mold and mildew resistant coating applied to any of said aeration material, said accumulation pan and said collection sump.

7. The sprinkler runoff conservation system, as described in claim 1, wherein said runoff collection sump further comprises a removable, cleanable filter, said filter disposed adjacent said collection point and providing a diversion path to said community runoff system should said filter be sufficiently clogged to prevent water flow through said collection point into said collection sump.

8. The sprinkler runoff conservation system, as described in claim 1, wherein said sump pump further comprises a float switch, said float switch cutting power to said pump if water in said collection sump falls below a second predetermined level.

9. The sprinkler runoff conservation system, as described in claim 2, wherein said sprinkler line shutoff valve further comprises a manual shutoff feature to permit timely repair of broken sprinkler heads or said tubing section to which said shutoff valve is fluidly connected.

10. The sprinkler runoff conservation system, as described in claim 1, further comprising either of a visual and auditory signal, said signal being activated when said pressure sensor detects said predetermined pressure drop in said tubing section during said irrigation period.
